(19) United States
(12) Patent Application Publication
(10) Pub. No.: US 2013/0130897 A1
(43) Pub. Date: May 23, 2013

(54) IMPROVING ACTIVITY OF CORN GLUTEN MEAL AS AN HERBICIDE USING DRY ACID TREATMENT

(71) Applicants: Nick E. Christians, Nevada, IA (US); Renate Hippen, Ames, IA (US)

(72) Inventors: Nick E. Christians, Nevada, IA (US); Renate Hippen, Ames, IA (US)

(73) Assignee: Iowa State University Research Foundation Inc., Ames, IA (US)

(21) Appl. No.: 13/574,567

(22) PCT Filed: Jul. 19, 2012
(86) PCT No.: PCT/US12/47452

§ 371 Date: Feb. 6, 2013

Related U.S. Application Data
(60) Provisional application No. 61/515,476, filed on Aug. 5, 2011.

(51) Int. Cl. A01N 65/08; A01N 65/44

(52) U.S. Cl. CPC A01N 65/08
USPC 504/116.1

(57) ABSTRACT

A composition comprises a substantially dry mixture of substantially dry corn gluten meal and substantially dry solid acid, wherein the amount of the substantially dry solid acid is effective to enhance the pre-emergence herbicidal activity of the substantially dry corn gluten meal. A method for selectively inhibiting the growth of undesirable plants comprises prior to the emergence of the undesirable plants, applying a substantially dry corn gluten meal and a substantially dry solid acid to a plot of soil so that the amount of the substantially dry solid acid applied to the plot of soil is effective to enhance the pre-emergence herbicidal activity of the substantially dry corn gluten meal, wherein the substantially dry corn gluten meal and the substantially dry solid acid are applied in an amount effective to inhibit the growth of the undesirable plants.

### CROSS-REFERENCE TO RELATED APPLICATIONS

This application claims the benefit of priority to U.S. Provisional Patent Application Ser. No. 61/515,476, entitled “IMPROVING ACTIVITY OF CORN GLUTEN MEAL AS AN HERBICIDE USING DRY ACID TREATMENT,” filed on Aug. 5, 2011, which is hereby incorporated by reference in its entirety.

### TECHNICAL FIELD

The present disclosure is directed to a corn gluten meal having enhanced herbicidal properties, and in particular to a composition comprising a substantially dry corn gluten meal and a substantially dry acid that provides for improved activity as an herbicide compared to corn gluten meal alone. The present disclosure also relates to a method of forming the composition.

### BACKGROUND

The growing concern for the environment and the rising popularity of naturally grown or “organic” crops has led to an increased need for natural weed control. In many farming operations, weeds are a serious problem. A growing demand for natural weed control calls for more effective natural alternatives.

Corn gluten meal (CGM) possesses natural preemergence weed control properties that have long been known to provide broad spectrum control of weeds in turfgrass and other crops. See, for example, Bingaman, B. R. and N. E. Christians, 30 Hort Science 1256-59 (1995), Christians, U.S. Pat. No. 5,030,268, Christians, 7 Ind. Turf. Soc. Res. J. 284-90 (1993), and Nonnecke, G. R. and N. E. Christians, 348 Acta Horticulturae 315-20 (1993). As a byproduct of the corn wet-milling process, CGM is often used as a feed additive for animals. The nontoxic nature of CGM has led the Environmental Protection Agency (EPA) to declare CGM exempt from the regulations to which synthetic pesticides must adhere. 40 C.F.R. §152.25(g); see also Environmental Protection Agency, Corn Gluten; Proposed Exemption From the Requirement of a Pesticide Tolerance, 62 Fed. Reg. 60660 (Nov. 12, 1997).

### SUMMARY

The present invention is generally directed to a composition that may be used as a natural herbicide for the control of weeds. Given the increased demand for natural herbicides, increasing the herbicidal activity of existing natural products such as CGM is of great interest. The present disclosure provides a composition comprising a substantially dry mixture comprising solid corn gluten meal (CGM) and at least one substantially dry solid acid, such as citric acid or ethylenediaminetetraacetic acid (EDTA). The substantially dry mixture exhibits increased herbicidal activity over CGM alone, while being relatively inexpensive to prepare compared to methods comprising acidifying aqueous suspensions or streams of CGM followed by drying the acidified CGM.

In one example, the present invention is directed to a composition comprising a substantially dry mixture of a substantially dry corn gluten meal, and a substantially dry solid acid, wherein the amount of the substantially dry solid acid is effective to enhance the pre-emergence herbicidal activity of the substantially dry corn gluten meal.

In another example, the present invention is directed to a composition comprising a substantially dry mixture of a substantially dry corn gluten meal, and a substantially dry solid citric acid, wherein the amount of the substantially dry solid citric acid is effective to enhance the pre-emergence herbicidal activity of the substantially dry corn gluten meal.

In another example, the present invention is directed to a method comprising mixing a substantially dry corn gluten meal with a substantially dry solid acid to form a substantially dry mixture, wherein the amount of the substantially dry solid acid in the substantially dry mixture is effective to enhance the pre-emergence herbicidal activity of the substantially dry corn gluten meal.

In another example, the present invention is directed to a kit comprising separately packaged substantially dry corn gluten meal and substantially dry solid acid, and instructions for applying the substantially dry corn gluten meal and the substantially dry solid acid to a plot of soil so that the amount of the substantially dry solid acid applied to the plot of soil is effective to enhance the pre-emergence herbicidal activity of the substantially dry corn gluten meal.

In another example, the present invention is directed to a method for selectively inhibiting the growth of undesirable plants, the method comprising, prior to the emergence of the undesirable plants in a plot of soil, applying a substantially dry corn gluten meal and a substantially dry solid acid to the plot of soil so that the amount of the substantially dry solid acid applied to the plot of soil is effective to enhance the pre-emergence herbicidal activity of the substantially dry corn gluten meal, wherein the substantially dry corn gluten meal and the substantially dry acid are applied in an amount effective to inhibit the growth of the undesirable plants, while not adversely affective the growth of desirable plants.

### BRIEF DESCRIPTION OF THE DRAWINGS

FIG. 1 is a graph showing perennial ryegrass seedling counts after germination while exposing the soil holding the seedlings to about 97.6 g/m² (about 20 lbs./1000 ft²) of substantially dry mixtures of substantially dry 78% protein corn gluten meal (CGM) and substantially dry ethylenediaminetetraacetic acid (EDTA) at 1%, 2%, 3%, 4%, 6%, 8%, and 10% weight EDTA/weight CGM, as well as a first control with no CGM or EDTA applied and a second control with 0% EDTA (100% CGM).

FIG. 2 is a graph showing perennial ryegrass seedling counts after germination while exposing the soil holding the seedlings to substantially dry mixtures of substantially dry 78% protein CGM and substantially dry EDTA at 2%, 3%, 4%, 6%, 8%, and 10% weight EDTA/weight CGM, as well as a first control with no CGM or EDTA applied and a second control with 0% EDTA (100% CGM). Each of these mixtures were applied at about 24.4 g/m² (about 5 lbs./1000 ft²), about 48.8 g/m² (about 10 lbs./1000 ft²), 73.2 g/m² (about 15 lbs./1000 ft²), and about 97.6 g/m² (about 20 lbs./1000 ft²).

FIG. 3 is a graph showing perennial ryegrass seedling counts after germination while exposing the soil holding the seedlings to substantially dry mixtures of substantially dry 60% protein CGM and various substantially dry acids at about 73.2 g/m² (about 15 lbs./1000 ft²). Mixtures of 60% protein CGM and substantially dry particles o EDTA, L-ascorbic acid, citric acid, and ammonium sulfate ((NH₄)₂SO₄) were investigated at 0.25%, 0.5%, 0.75% and 1% weight dry acid/weight CGM, along with a first control with no CGM or acid applied and a second control with 0% dry acid (100% CGM).

FIG. 4 is a graph showing perennial ryegrass seedling counts after germination while exposing the soil holding the seedlings to substantially dry mixtures of 78% protein CGM and various substantially dry acids at about 73.2 g/m² (about 15 lbs./1000 ft²). Mixtures of 78% protein CGM and substantially dry particles of EDTA, L-ascorbic acid, citric acid, and ammonium sulfate ((NH₄)₂SO₄) were investigated at of 0.25%, 0.5%, 0.75% and 1% weight dry acid/weight CGM, along with a first control with no CGM or acid applied and a second control that was 0% dry acid (100% CGM).

FIG. 5 is a graph showing perennial ryegrass seedling counts after germination while exposing the soil holding the seedlings to substantially dry mixtures of 60% protein CGM and substantially dry citric acid applied at about 73.2 g/m² (about 15 lbs./1000 ft²) at 0.25%, 0.5%, 0.75%, and 1% weight citric acid/weight CGM, along with a first control with no CGM or citric acid applied and a second control that was 0% citric acid (100% CGM).

### DETAILED DESCRIPTION OF THE INVENTION

The present disclosure is directed generally to a composition that may be used as a natural herbicide, e.g., as a pre-emergence herbicide, for the control of undesirable plants, such as weeds in a stand of one or more desirable plants. Given the increased demand for natural herbicides, increasing the herbicidal activity of existing natural herbicides such as corn gluten meal (CGM) is of great interest. It has been found that treating an aqueous suspension of corn gluten protein with an aqueous acid followed by drying the aqueous suspension to form a CGM with a reduced pH can increase the herbicidal activity of the CGM as an herbicide over non-treated CGM. See Christians, U.S. application Ser. No. 12/762,863, filed on Apr. 19, 2010, published as U.S. Publication 2010/0267562 on Oct. 21, 2010, the entire disclosure of which is incorporated by reference as if reproduced herein. However, the procedure described in U.S. Publication 2010/0267562 for acidifying and then drying an aqueous suspension of corn gluten protein is difficult and expensive.

The present disclosure relates generally to a composition comprising substantially dry, solid CGM and a substantially dry, solid acid, wherein the substantially dry acid is applied in an amount that is sufficient to improve the herbicidal activity of the CGM. As used herein, the phrase “sufficient to improve the herbicidal activity of the CGM,” or “effective in improving the herbicidal activity,” or “an effective amount of the substantially dry acid,” refers to the substantially dry acid having a noticeable effect, and in some examples a statistically significant effect, on the herbicidal activity of the CGM, e.g., the ability of the CGM to act as a pre-emergence herbicide, beyond the activity of the CGM used alone (e.g., the CGM without the addition of acid).

In some examples, an effective amount of the substantially dry acid may occur when the weight of the acid is from about 0.01% to about 1% of the weight of the CGM. In some examples, a substantially dry mixture of the CGM and substantially dry acid is formed such that the amount of dry acid in the mixture is sufficient to improve the activity of the CGM as an herbicide, e.g., wherein the weight of the dry acid is from about 0.01% to about 0.5% of the weight of the CGM.

The composition of the present disclosure comprising substantially dry CGM and substantially dry acid possesses increased herbicidal activity over CGM alone, while being relatively inexpensive to make compared to methods comprising acidifying an aqueous suspension of CGM and then drying the acidified CGM. It has been found that a substantially dry composition of CGM and a substantially dry acid such as substantially dry citric acid applied to a plot of soil provides for improved herbicidal activity that is comparable to, or even superior to, the activity that is seen by acidifying an aqueous suspension of CGM with an aqueous acid, and then drying the suspension, as in Christians, U.S. Publication 2010/0267562.

The present disclosure is also directed generally to a method of making a natural herbicide, the method comprising mixing a substantially dry CGM and at least one substantially dry acid to form a substantially dry mixture, wherein the amount of the dry acid is effective to enhancing the herbicidal activity of CGM, e.g., wherein the weight of the dry acid is from about 0.01% to about 1% of the weight of the CGM. The present invention provides a composition formed by this method. The present invention also provides a kit comprising separately packaged substantially dry CGM, at least one substantially dry acid, and instructions for applying the substantially dry CGM and the substantially dry acid to a plot of soil in order to inhibit the growth of undesirable plants. The present invention further provides a method for selectively inhibiting the growth of undesirable plants in a stand of desirable plants in a plot of soil comprising applying a substantially dry corn gluten meal and a substantially dry acid to a plot of soil prior to emergence of undesirable plants.

As used herein, the term “substantially dry” means that the component in question (e.g., substantially dry CGM, substantially dry acid, substantially dry mixture) is primarily comprised of solid particles with an amount of moisture (e.g., water) that is less than the amount of moisture that would be needed to form an aqueous solution including the component in question and/or with a moisture content that is less than the amount of moisture that would result in sticking or conglomeration of particles of the solid component. In one example, the substantially dry composition of the present invention is made up of flowable solid granules or particles.

In some examples, in the case of CGM having a protein concentration of from about 50% protein to about 80% protein (dry basis), the CGM may be considered “substantially dry” if it has a moisture content of less than or equal to about 15% weight, moisture/weight CGM, such as less than or equal to about 12% weight moisture/weight CGM, for example less than or equal to about 10% weight moisture/weight CGM. In some examples, in the case of dry acid, such as citric acid or ethylenediaminetetraacetic acid (EDTA), the acid may be considered “substantially dry” if it has a moisture content of less than or equal to about 15% weight moisture/weight acid, such as less than or equal to about 12% weight moisture/weight acid, for example less than or equal to about 10% weight moisture/weight acid. In some examples where the acid is citric acid, citric acid monohydrate may be used, which is up to about 10% weight water/weight acid, or anhydrous citric acid may be used, which is 0.5% weight water/weigh acid or less. In some examples, in the case of a mixture of CGM and a dry acid, the mixture may be considered “substantially dry” if it has a moisture content of less than or equal to about 15% weight moisture/weight mixture, such as less than or equal to about 12% weight moisture/weight mixture, for example less than or equal to about 10% weight moisture/weight mixture.

As described in Christians, U.S. Pat. No 5,030,268 and Christians, U.S. Publication 2010/0267562, corn gluten meal (CGM) has a natural herbicidal activity when applied to soil before the emergence of undesirable plants, such as weeds, e.g., it may be used as a “preemergence herbicide.” CGM is commercially available as a by-product of corn milling (for example, it is commercially available from many sources including Grain Processing Corporation of Muscatine, Iowa). Wet milling corn can comprise separating the corn into corn starch, corn oil, defatted corn germ, corn hulls, corn steep liquor, and corn gluten (the protein fraction). Corn gluten is typically separated from the starch stream by centrifugation to yield thick, yellow slurry of corn gluten containing from about 15% and about 20% solids.

In some cases, CGM is made by drying the liquid gluten slurry, such as by filtering and drying the separated corn gluten slurry to produce solid, substantially dry corn gluten meal. In some examples, the resulting corn gluten meal may be from about 68% and about 80% protein, which may be diluted down to a desired protein level, such as about 60% protein (on a dry basis). The dried CGM may be packaged and sold as an animal feed product. Corn gluten meal is quite insoluble in water and is typically composed of protein (60-80%, dry basis) carbohydrate (20-25%, dry basis), fat (3-5%, dry basis) and ash (3-5%, dry basis).

The substantially dry CGM that may be used to form an herbicide composition according to the present disclosure may comprise from about 50% protein (dry basis) to about 80% protein (dry basis), for example from about 60% to about 78%, such as about 60%, about 68%, about 70%, or about 78% protein. The CGM, however, can include higher and lower protein concentrations, e.g., about 45%, about 50%, about 55%, about 65%, about 70%, about 75%, about 80%, about 85%. CGM with higher protein percentages (e.g., above 60%) also have a significant nitrogen content to provide enhanced activity of the CGM such that the CGM may also act as a fertilizer source of slow-release nitrogen (N).

In one example, the substantially dry CGM comprises substantially dry, solid particles of CGM. The particles of corn gluten meal may be mixed or dry blended, e.g., with a tumble mixer or ribbon blender, with particles of substantially dry acid to form a substantially dry mixture of CGM and acid or the corn gluten meal can be applied to soil separately from the substantially dry acid particles. In one example, particles of CGM may have a particle size (e.g., a size of the largest linear dimension) of less than about 3 mm, for example less than about 2.5 mm, such as less than about 2 mm, for example less than about 1 mm. In some examples, the CGM may be from a fine powdered size, around about 0.1 mm to about 0.125 mm or less, up to about 2.5 mm. In one example, the particles of CGM and the particles of dry acid may be mixed and reduced in size at substantially the same time using a grinder that both reduces particle size and mixes or blends the CGM and acid together.

The substantially dry acid that may be used to form an herbicide composition according to the present disclosure may comprise any solid or particulate acid that can be readily combined with solid, substantially dry CGM, e.g., by solid blending techniques, in an amount that is effective to increase the activity of the CGM as an herbicide. In some examples, the substantially dry acid comprises an acid that, like CGM, is generally recognized as safe, e.g., for human consumption, or that is exempt from regulations to which synthetic pesticides generally must adhere, such as the regulations promulgated by the U.S. Environmental Protection Agency, such as citric acid. In one example, the substantially dry acid comprises at least one of substantially dry citric acid, substantially dry ethylenediaminetetraacetic acid (EDTA), substantially dry L-ascorbic acid, or substantially dry ammonium sulfate ([NH₄⁺]₂[SO₄²⁻]), or combinations thereof. In one example, citric acid, such as citric acid monohydrate, is used as the substantially dry acid.

In one example, the substantially dry acid comprises substantially dry, solid particles of acid. The particles of substantially dry acid can be mixed or dry blended with particles of substantially dry to form a substantially dry mixture of CGM and acid. Alternatively, the acid can be applied to soil separately from the substantially dry CGM particles. In one example, particles of acid may have a particle size (e.g., a size of the largest linear dimension) of less than about 3 mm, for example less than about 2.5 mm, such as less than about 2 mm, for example less than about 1 mm. In some examples, the acid may be from a fine powdered size, e.g., around about 0.1 mm to about 0.125 mm or less, up to about 2.5 mm.

The substantially dry CGM and the substantially dry acid are applied to a plot of soil in order to keep undesirable plants, such as weeds from emerging. The weight of the substantially dry acid applied to the soil is an amount that is effective in enhancing the herbicidal activity of the CGM as an herbicide over that of CGM alone.

The weight that may be considered an effective amount for enhancing the herbicidal activity of the CGM may depend on the type of substantially dry acid used, the protein concentration of the CGM used, and the application rate (e.g., g/m²) of the CGM and the acid to the soil.

For example, as shown in the Examples below, if EDTA is used as the substantially dry acid with a CGM that is about 78% protein and wherein the CGM and EDTA combined are applied at about 73.2 g/m² (about 15 lbs./1000 ft²), an effective amount of the EDTA may be a weight of from about 0.5% to about 4% of the weight of the CGM, such as from about 1% to about 3% of the weight of the CGM.

In another example where citric acid is used as the substantially dry acid with a CGM that is about 60% protein and wherein the CGM and citric acid combined are applied at about 73.2 g/m² (about 15 lbs./1000 ft²), an effective amount of the citric acid may be a weight of from about 0.01% to about 0.5% of the weight of the CGM, such as from about 0.1% to about 0.3% of the CGM weight, for example about 0.25% of the CGM weight.

In yet another example where L-ascorbic acid is used as the substantially dry acid with a CGM that is about 60% protein and wherein the CGM and L-ascorbic acid combined are applied at about 73.2 g/m² (about 15 lbs./1000 ft²), an effective amount of the L-ascorbic acid may be a weight from about 0.1% to about 0.75% of weight of the CGM, such as from about 0.25% to about 0.5% of the CGM weight.

In still another example where ammonium sulfate is used as the substantially dry acid with a CGM that is about 60% protein and wherein the CGM and citric acid combined are applied at about 73.2 g/m² (about 15 lbs./1000 ft²), an effective amount of the ammonium sulfate may be a weight from about 0.5% to about 1% of the weight of the CGM, such about 0.75% of the CGM weight.

In one example, the substantially dry CGM and the substantially dry acid are applied to a plot of soil substantially at the same time, e.g., with particles of CGM and particles being applied substantially concurrently. In another example, the substantially dry CGM and the substantially dry acid may be applied separately to the soil, so long as the CGM and acid are applied proximate enough in time so that the acid will enhance the herbicidal activity of the CGM.

In another example, the particles of substantially dry CGM may be dry mixed or dry blended with the particles of substantially dry acid to form a substantially dry mixture having an amount of the substantially dry acid that is effective in enhancing the herbicidal activity of the CGM. This substantially dry mixture may then be applied to the soil. Mixing the substantially dry CGM and the substantially dry acid to form a substantially dry mixture may advantageously allow for greater control of the relative amount of the acid to the amount of the CGM as well as providing for more uniform dispersion of the CGM and the acid that is applied to the soil.

In one example, the substantially dry mixture is substantially homogeneous throughout so that the concentration of the substantially dry CGM particles and the substantially dry acid particles is substantially uniform throughout the mixture. Mixing of the substantially dry CGM and the substantially dry acid may be performed by a manufacturer or supplier, or the mixing of the substantially dry CGM and substantially thy acid may be performed by an end user, such as a customer, homeowner, lawn or turf maintenance worker, farmer, and the like.

As noted above, the composition comprising substantially dry CGM and substantially dry acid may be provided to an end user, such as a customer, homeowner, gardener, farmer, turf or grass maintenance worker, etc., as a mixture that is premixed so that the weight of the substantially dry acid as a percentage of the CGM weight is sufficient to enhance the herbicidal activity of the CGM. However, the substantially dry CGM and the substantially dry acid may also be provided to the end user in the form of a kit comprising the substantially dry CGM packaged separately from the substantially dry acid, e.g., in separate containers, bags, boxes, etc. The kit may further comprise instructions for the end user for mixing and/or applying the substantially dry CGM and the substantially dry acid to a plot of soil in a ratio so that the weight percent of the substantially dry acid applied to the soil is sufficient to enhance the herbicidal activity of the substantially dry CGM.

In one example, the kit may comprise a predetermined weight of the substantially dry CGM and a predetermined weight of the substantially dry acid, wherein each predetermined weight is selected so that, when the entire predetermined weight of both the substantially dry CGM and the substantially dry acid are applied to the soil, the combination of the substantially dry CGM and the substantially dry acid will have a weight of the substantially dry acid that is sufficient to enhance the herbicidal activity of the CGM, such as a weight of the substantially dry acid from about 0.01% to about 1% of the weight of the CGM. In such a kit, the end user need not be asked to measure precise amounts of the substantially dry CGM or the substantially dry acid, but rather merely needs to apply, and if desired mix, the entirety of each of the components provided. In some examples, the predetermined weight of the substantially dry CGM and the substantially dry acid in a particular kit may also be selected for a predetermined area of soil, such as 1 m², 10 ft², 1 acre, etc., so that the end user does not need to measure or weigh precise amounts of the CGM, acid, or mixture (if desired), but rather merely acquires the number of kits that are necessary for the specific soil area that is desired to be treated.

The instructions may instruct the user to apply the substantially dry CGM and the substantially dry acid to the plot of soil separately, substantially concurrently, or as a mixture. The instructions may further instruct the end user to apply the substantially dry CGM and the substantially dry acid so that the weight of the substantially dry acid is from about 0.01% to about 1% of the weight of the CGM.

The instructions may further instruct the end user to mix the substantially dry CGM and the substantially dry acid in an amount that is sufficient to enhance the herbicidal activity of the CGM, e.g., a weight of the substantially dry acid that is from about 0.01% to about 1% of the weight of the CGM, prior to applying the substantially dry CGM and the substantially dry acid to the plot of soil. The instructions may also instruct the end user to apply the substantially dry CGM and the substantially dry acid at an application rate of from about 5 lbs./1000 ft² (about 24 g/m²) to about 40 lbs./1000 ft² (about 195.2 g/m²), such as about 48.8 g/m² (about 10 lbs./1000 ft²), about 73.2 g/m² (about 15 lbs./1000 ft²), or about 97.6 g/m² (about 20 lbs./1000 ft²).

As described above, in some examples the substantially dry CGM and/or the substantially dry acid may be in the form of particles. In one example, the substantially dry CGM and the substantially dry acid may be subjected to grinding or granulation to reduce the size of larger particles down to a desired particle size, less than about 3 mm, for example less than about 2.5 mm, such as less than about 2 mm, for example less than about 1 mm. In some examples, the particles may be from a fine powdered size, e.g., around about 0.1 mm to about 0.125 mm or less, up to about 2.5 mm. In one example, the substantially dry CGM and the substantially dry acid are mixed or blended together to form a substantially dry mixture, as described above, followed by grinding the substantially dry mixture. In one example, the substantially dry acid has an average particle size that is smaller than an average particle size of the CGM so that the substantially dry acid will provide for substantial coverage of the particles of CGM. In one example, the CGM has a particle size of about 1 mm to about 2.5 mm, while the substantially dry acid has a smaller, powder-like particle size, e.g., about 0.1 mm to about 0.15 mm.

The composition of the substantially dry CGM and the substantially dry acid may be applied to a soil in order to prevent or reduce emergence of undesirable plants, such as grassy weeds or broadleaf weeds in a plot comprising established desirable plants. While applicant does not wish to be bound by any theory, it is believed that the CGM/acid composition, when applied to a soil plot, inhibits root development of undesirable plants or “weeds” around the time of germination. As a result, as soon as the plant begins to grow, it will undergo root stress and die. Thus, while the corn gluten meal does not prohibit germination, it nevertheless does not allow the root structure to develop sufficient that the undesirable plant can grow to a healthy plant. As a result, the undesirable plant dies from the lack of root growth.

The dry product can be applied by the use of conventional spreaders or dusters used for solid fertilizers or herbicides and can be applied as a dust, pellets, granules and the like. The amount of corn gluten meal and acid that is applied to soil, referred to herein as the application rate, can vary over a wide range, which may depend on many factors including the type of undesirable plant, the type of soil, the type of desirable plants, the protein content of the CGM, the type of substantially dry acid, the weight of acid (e.g., as a percent of the CGM weight), etc.

Application rate is generally described as the mass of the CGM and the acid applied per area of soil, such as in grams per square meter (g/m²), or as is traditional in American farming, pounds per 1000 square feet (lbs./1000 ft²). For example, the corn gluten meal and acid of the present disclosure can be applied at a rate of from about 0.3 grams/m² (about 0.06 lbs./1000 ft²) to about 1000 g/m² (about 205 lbs./1000 ft²) of soil area, such as at a rate of from about 25 g/m² (about 5.1 lbs./1000 ft²) to about 400 g/m² (about 82 lbs./1000 ft²) of soil area, for example from about 40 g/m² (about 8.2 lbs./1000 ft²) to about 100 g/m² (about 20.5 lbs. 1000 ft²), such as about 48.8 g/m² (about 10 lbs./1000 ft²), about 73.2 g/m² (about 15 lbs./1000 ft), and about 97.6 g/m² (about 20 lbs./1000 ft²).

The composition can be simply surface-applied, or it can be mixed into the upper layer of the soil following application. As used herein “soil” or “plot of soil” is intended broadly cover volumes of solid plant support material such as the mixture of organic and inorganic materials conventionally referred to as “soil,” as well as synthetic soils (or “soilless soils”) and other solid supports such as beds of pebbles, sand, moss and the like. The solid plant support material may be potted, or otherwise contained, or may be a preselected portion of the ground.

The composition of the substantially dry CGM and the substantially dry acid is effective to prevent the emergence of a wide variety of undesirable plants, including broadleaf weeds, such as smartweed, velvetleaf, redroot, pigweed, lambsquarters, latchweed, bedstraw, black medic, buckhorn plantain, annual purslane, black and nightshade; and grassy weeds such as crabgrass, annual bluegrass, creeping bentgrass, barnyard grass, orchard grass, woolly cupgrass, foxtails, shattercane, Kentucky bluegrass, Bermudagrass, perennial ryegrass and tall fescue.

The corn gluten meal and acid can be used as a preemergence herbicide for application to established plots of desirable plants, including both monocotyledonous plants and dicotyledonous plants. Monocotyledonous crops include grains, such as corn, sorghum, rice, oats, wheat, rye, millet, turfgrasses and the like. Dicotyledonous crops include fruits, fibers, herbs, vegetables, ornamental flowers and foliage, legumes, berry plants such as strawberries, blueberries and raspberries, soybeans, potatoes, spinach, cauliflower, tomatoes, tobacco, beans, beets, cotton, peas, squash, melons, canola and the like.

As recognized by those skilled in the art, preemergence herbicides are generally applied after the emergence or rooting of the desirable plants, but prior to weed emergence. The timing of application will vary, depending upon the specific crop production system, the area of the country in which the CGM and acid is applied and the weed species involved. For example, in general, for areas of the upper Midwest, application is desirable prior to May 1st of any growing season, for control of crabgrass. An appropriate time for application of the CGM and acid composition of the present disclosure may be readily determined by a person of skill in the art.

Following planting or establishing of desirable plants in the plot and application of the substantially dry CGM and substantially dry acid to the soil, additional amounts of CGM, either alone or in combination with more acid, can be applied as needed, to prevent the growth of undesirable plants while not inhibiting the growth of the desirable plants, or otherwise harming them.

### EXAMPLES

The following examples are provided in order to demonstrate and further illustrate certain embodiments and aspects of the present disclosure and are not to be construed as limiting the scope thereof.

### Example 1

A substantially dry corn gluten meal (CGM) having a protein concentration of about 78% protein was mixed with substantially dry ethylenediaminetetraacetic acid (EDTA). The CGM and EDTA mixture was ground in a mortal with a pestle so that particles of the CGM and EDTA reached a desired particle size. The ground mixture was allowed to remain at room temperature for 7 days before the study was initiated.

The test samples included the 78% protein CGM with a weight of EDTA of 1%, 2%, 3%, 4%, 6%, 8%, and 10% of the CGM weigh. A CGM control sample with 0% EDTA (e.g., 100% CGM) was also prepared.

The materials were applied to the surface of the pots at a. rate equivalent to the standard commercial rate of about 20 pounds product per 1000 ft² of surface area (about 97.6 g/m²). The material was applied to the surface of 16 in² (about 0.01 m²) pots filled with field soil and seeded with 0.25 g perennial ryegrass (Lolium perenne) seed/pot (equivalent to about 24 g seed/m² soil or about 5 lbs seed/1000 ft² soil). A control pot with no CGM applied was also seeded.

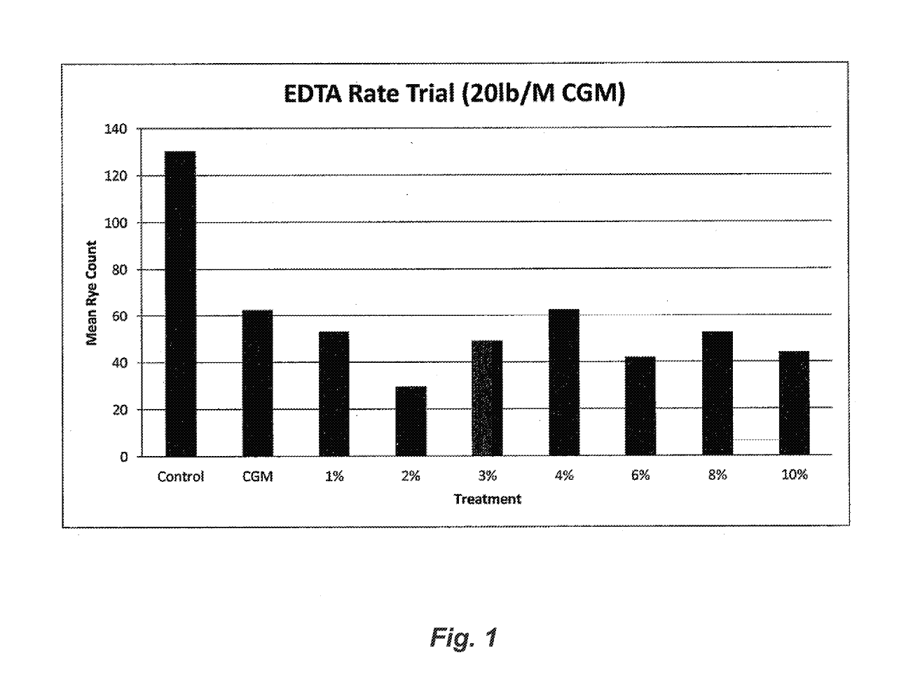

The pots were then watered on a mist bench in a greenhouse and the seed was allowed to germinate. After germination, watering was ceased and the surface of the soil was allowed to dry. The number of surviving perennial ryegrass plants in each pot was then counted. The results of the study of Example 1 are shown in FIG. 1.

While several of the CGM and EDTA mixtures showed a numerical reduction in test plant survival over the application of CGM alone, e.g., 1%, 2%, 3%, 6%, 8%. and 10%, most notably 2%, none of the mixtures showed a statistically significant reduction. While not wishing to be bound to any theory, it was theorized by the applicant that the 20 lbs/1000 ft² (about 97.6 g/m²) application rate of the mixture comprising 78% protein CGM and EDTA may have been too high.

### Example 2

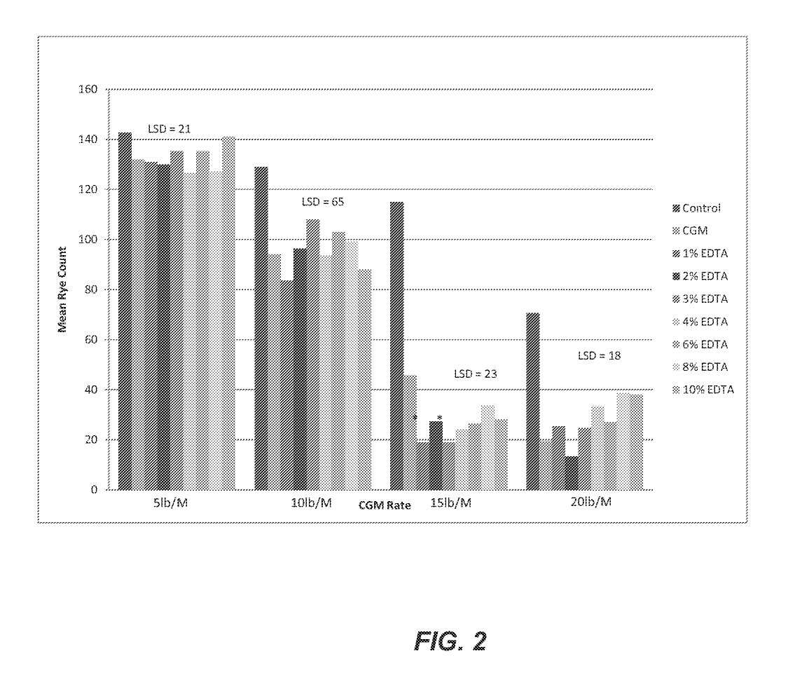

In order to test the theory from Example 1 that the application rate of 20 lbs/1000 ft² (about 97.6 g/m²) for the mixture comprising 78% protein CGM and EDTA was too high, the same mixtures of substantially dry CGM having a protein concentration of 78% protein and substantially dry EDTA from Example 1 were prepared (e.g., at a EDTA weight of 0%, 1%, 2%, 3%, 4%, 6%, 8%, and 10% of the weight of the CGM. Studies of each EDTA concentration along with the CGM control was conducted on 16 in² (about 0.01 m²) pots filled and seeded in the same manner as in Example 1 at application rates of about 5 lbs./1000 ft² (about 24.4 g/m²), about 10 lbs./1000 ft² (about 48.8 g/m²), about 15 lbs./1000 ft² (about 73.2 g/m²), and about 20 lbs./1000 ft² (about 97.6 g/m²). The resulting perennial ryegrass plant survival counts of these studies are shown in FIG. 2.

As shown in FIG. 2, the 5 lbs./1000 ft² and 10 lbs./1000 ft² application rates did not provide for statistically significant control over plant emergence compared to the CGM control, and also did not appear to provide for satisfactory prevention of emergence over the control (e.g., no CGM). However, the 15 lbs/1000 ft² application rate provided for a statistically significant improvement of herbicidal activity over the CGM control at the 1% and 3% EDTA concentrations.

### Example 3

In this example, other solid acids were investigated. A first batch of mixtures of a substantially dry CGM having a protein concentration of 60% protein with various amounts of EDTA, L-ascorbic acid, citric acid, and ammonium sulfate ((NH₄)₂SO₄) were prepared. A second batch of mixtures of a substantially dry CGM having a protein concentration of 78% protein with various amounts of EDTA, L-ascorbic acid, citric acid, and ammonium sulfate ((NH₄)2SO4) were also prepared. Acid weights of 0% (CGM control), 0.25%, 0.5%, 0.75%, and 1% acid of the weight of the CGM were prepared.

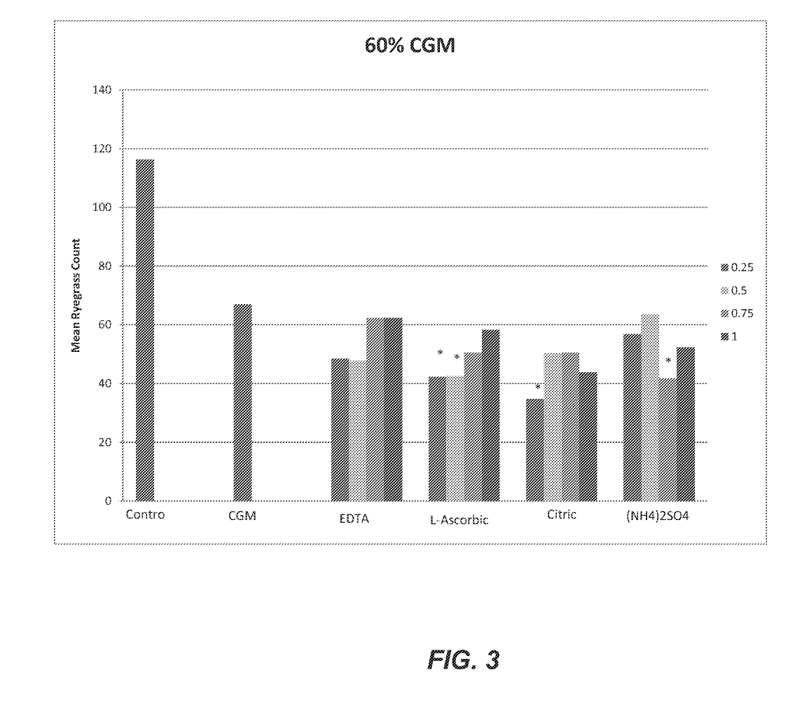

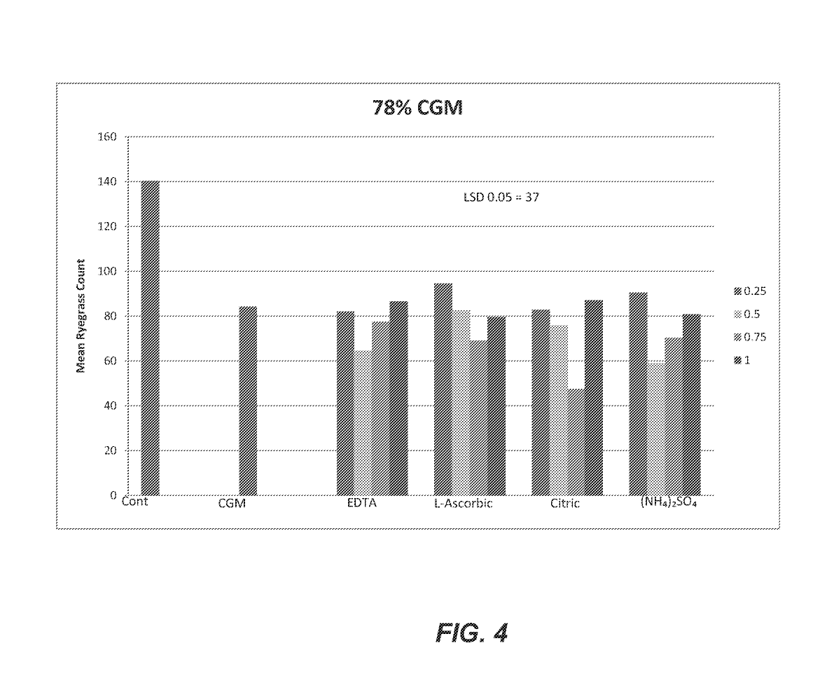

Each mixture was applied to 16 in² (about 0.01 m²) pots filled and seeded in the same manner as in Example 1 at an application rate of about 15 lbs./1000 ft² (about 73.2 g/m²). The results of the first batch of mixtures (e.g., with 60% protein CGM) is shown in FIG. 3. The results of the second batch of mixtures (e.g., with 78% protein CGM) is shown in FIG. 4.

As shown in FIG. 3, L-ascorbic acid demonstrated a statistically significant improvement of the herbicidal activity of the 60% protein CGM at weights of 0.25% and 0.5% of the CGM weight, citric acid demonstrated a statistically significant improvement of the herbicidal activity at the 0.25% weight, and ammonium sulfate improved activity at the 0.75% weight. As shown in FIG. 4, there were no statistically significant effects from any of the acids on the 78% protein CGM. However, there was a problem with watering in the study of the 78% protein CGM which may have affected the results.

### Example 4

A more focused study on citric acid was conducted. A substantially dry CGM having a protein concentration of 60% protein was mixed with a substantially dry citric acid monohydrate with the citric acid having a weight of 0.25%, 0.5%, 0.75% and 1% of the weight of the CGM. A control of no CGM and no acid and a CGM control of 100% CGM having 60% protein (0% citric acid) were also used.

Each sample of CGM or CGM/acid was ground in a mortar with a pestle and was then allowed to remain at room temperature for 7 days. The materials were applied to the surface of the pots at a rate equivalent to a standard commercial rate of about 15 pounds product per 1000 ft² of soil area (about 73.2 g/m²). The material was applied to the surface of 16 in² (about 0.01 m² ) pots filled with field soil and seeded with 0.25 g perennial ryegrass (Lolium perenne) seed/pot (equivalent to about 24 g seed/m² of soil or about 5 lbs seed/1000 ft² of soil). A control pot with no CGM applied was also seeded. Table 1 shows the actual weight of citric acid and CGM applied per pot.

TABLE 1

| | | % Acid | | |
|---|---|---|---|---|
| # | Treatment | (% w/w CGM) | Acid (g) | CGM (g) |
| 1 | Control | — | 0 | 0 |
| 2 | CGM no acid | — | 0 | 0.75 |
| 3 | CGM + Citric | 0.25 | 0.001875 | 0.75 |
| 4 | CGM + Citric | 0.50 | 0.00375 | 0.75 |
| 5 | CGM + Citric | 0.75 | 0.005625 | 0.75 |
| 6 | CGM + Citric | 1.00 | 0.0075 | 0.75 |

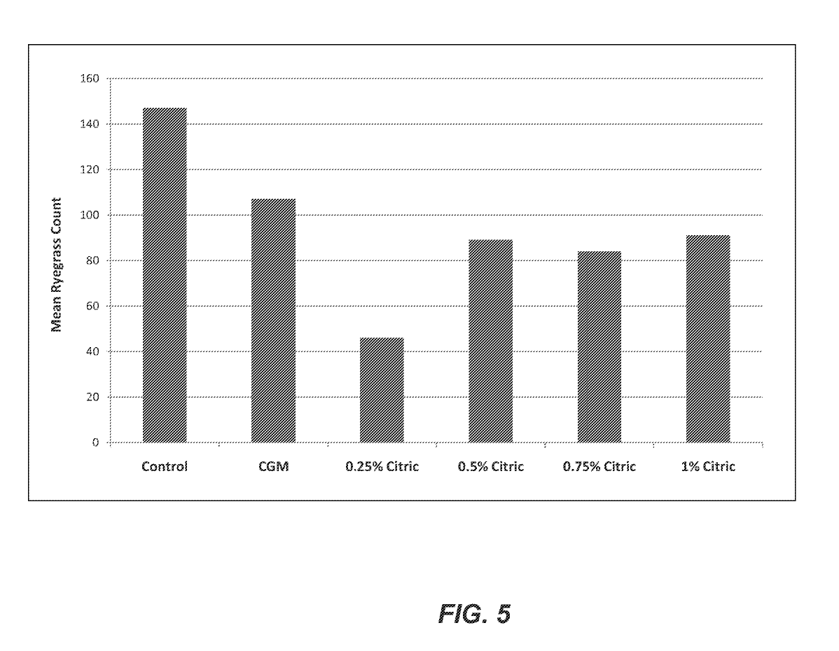

Each treatment was conducted in four replications, with each pot being watered on a mist bench in a greenhouse and the seed was allowed to germinate. Watering was then ceased and the surface of the soil was allowed to dry. The number of surviving perennial ryegrass plants in each pot was then counted. FIG. 5 shows the resulting average ryegrass plant count for each treatment.

An average of 147 live ryegrass plants remained in the untreated (Control) pots. The application of the CGM control (no acid) reduced the emergence of ryegrass plants by about 27% to an average of 107 plants. The addition of citric acid with a weight of 0.25% of the CGM weight resulted in a 68% reduction in emergence of perennial ryegrass plants aver the untreated control (from an average 147 plants for the control to an average of 46 plants for the 0.25% citric acid mixture), which was statistically significant.

The 0.25% citric acid mixture also resulted in a 57% reduction in the emergence of perennial ryegrass plants over the CGM control with no acid (from an average of 107 plants to an average of 46 plants for the 0.25% citric acid mixture). The 0.5%, 0.75%, and 1% citric acid mixtures also reduced the ryegrass plant eiriergence over the control (by 39.5%, 43%, and 38% respectively) and over the CGM control (by 7%, 21.5%, and 15% respectively). However, the reduction in tyegrass plant emergence for the 0.5%, 0.75%, and 1% citric acid mixtures was not statistically significant over the survival rate for CGM alone.

To better illustrate the compositions, kits, and methods disclosed herein, a non-limiting list of example Embodiments is provided herein:

Embodiment 1 can include subject matter (such as an apparatus, a device, a method, or one or more means for performing acts), such as can include a composition. The subject matter can comprise a substantially dry mixture of substantially dry corn gluten meal and substantially dry solid acid, wherein the amount of the substantially dry solid acid is effective to enhance the pre-emergence herbicidal activity of the substantially dry corn gluten meal.

Embodiment 2 can include, or can optionally be combined with the subject matter of Embodiment 1, to optionally include the substantially dry solid acid having a weight of from about 0.01% to about 1% of the weight of the substantially dry corn gluten meal.

Embodiment 3 can include, or can optionally be combined with the subject matter of one or any combination of Embodiments 1 or 2, to optionally include the substantially dry solid acid comprising at least one of citric acid, ethylenediaminetetraacetic acid, L-ascorbic acid, and ammonium sulfate.

Embodiment 4 can include, or can optionally be combined with the subject matter of one or any combination of Embodiments 1-3, to optionally include the corn gluten meal comprising from about 50% protein to about 80% protein on a dry basis.

Embodiment 5 can include, or can optionally be combined with the subject matter of one or any combination of Embodiments 1-4, to include subject matter (such as an apparatus, a composition, a kit, a device, a method, or one or more means for performing acts), such as can include a composition. The subject matter can include a substantially dry mixture of substantially dry corn gluten meal and substantially dry solid citric acid, wherein the amount of the substantially dry solid citric acid is effective to enhance the pre-emergence herbicidal activity of the substantially dry corn gluten meal.

Embodiment 6 can include, or can optionally be combined with the subject matter of one or any combination of Embodiments 1-5, to optionally include the substantially dry solid citric acid having a weight of from about 0.01% to about 0.5 % of a weight of the substantially dry corn gluten meal.

Embodiment 7 can include, or can optionally be combined with the subject matter of one or any combination of Embodiments 1-6, to optionally include the substantially dry solid citric acid having a weight of about 0.25% of a weight of the corn gluten meal.

Embodiment 8 can include, or can optionally be combined with the subject matter of one or any combination of Embodiments 1-7, to optionally include the substantially dry citric acid comprising at least one of citric acid monohydrate or anhydrous citric acid.

Embodiment 9 can include, or can optionally be combined with the subject matter of one or any combination of Embodiments 1-8, to optionally include the substantially dry citric acid consisting of at least one of citric acid monohydrate or anhydrous citric acid.

Embodiment 10 can include, or can optionally be combined with the subject matter of one or any combination of Embodiments 1-9, to optionally include the substantially dry citric acid consisting essentially of at least one of citric acid monohydrate or anhydrous citric acid.

Embodiment 11 can include, or can optionally be combined with the subject matter of one or any combination of Embodiments 1-10 to optionally include the corn gluten meal comprising from about 50% protein to about 80% protein on a dry basis.

Embodiment 12 can include, or can optionally be combined with the subject matter of one or any combination of Embodiments 1-11, to include subject matter (such as an apparatus, a composition, a kit, a device, a method, or one or more means for performing acts), such as can include a method. The subject matter can include mixing a substantially dry corn gluten meal with a substantially dry solid acid to form a substantially dry mixture, wherein the amount of the substantially dry solid acid in the substantially dry mixture is effective to enhance the pre-emergence herbicidal activity of the substantially dry corn gluten meal.

Embodiment 13 can include, or can optionally be combined with the subject matter of one or any combination of Embodiments 1-12, to optionally include the substantially dry solid acid having a weight of from about 0.01% to about 1% of a weight of the substantially dry corn gluten meal.

Embodiment 14 can include, or can optionally be combined with the subject matter of one or any combination of Embodiments 1-13, to optionally include grinding the corn gluten meal and the dry acid so that each have an average particle size of less than about 3 mm.

Embodiment 15 can include, or can optionally be combined with the subject matter of one or any combination of Embodiments 1-14, to optionally include the substantially dry solid acid comprising at least one of citric acid, ethylenediaminetetraacetic acid, L-ascorbic acid, or ammonium sulfate.

Embodiment 16 can include, or can optionally be combined with the subject matter of one or any combination of Embodiments 1-15, to optionally include the corn gluten meal comprising from about 50% protein to about 80% protein on a dry basis.

Embodiment 17 can include, or can optionally be combined with the subject matter of one or any combination of Embodiments 1-16, to optionally include applying the substantially dry mixture to a plot of soil prior to emergence of undesirable plants in an amount of the mixture effective to inhibit growth of the undesirable plants.

Embodiment 18 can include, or can optionally be combined with the subject matter of one or any combination of Embodiments 1-17, to optionally include the plot of soil comprising desirable plants.

Embodiment 19 can include, or can optionally be combined with the subject matter of one or any combination of Embodiments 1-18, to optionally include transplanting desirable plants into the plot of soil.

Embodiment 20 can include, or can optionally be combined with the subject matter of one or any combination of Embodiments 1-19, to optionally include the substantially dry mixture being applied to the plot of soil after transplanting the desirable plants into the plot of soil.

Embodiment 22 can include, or can optionally be combined with the subject matter of one or any combination of Embodiments 1-20, to optionally include the amount of the substantially dr mixture that is added to the plot of soil being from about 5 pounds to about 40 pounds per 1000 square feet.

Embodiment 22 can include, or can optionally be combined with the subject matter of one or any combination of Embodiments 1-21, to optionally include the amount of the substantially dry mixture that is added to the plot of soil being about 15 pounds per 1000 square feet of the soil.

Embodiment 23 can include, or can optionally be combined with the subject matter of one or any combination of Embodiments 1-22, to include subject matter (such as an apparatus, a composition, a kit, a device, a method, or one or more means for performing acts), such as can include a kit. The subject matter can include, separately packaged, a substantially dry corn gluten meal, a substantially dry solid acid, and instructions for applying the substantially dry corn gluten meal and the substantially dry acid to a plot of soil so that the amount of the substantially dry solid acid applied to the plot of soil is effective to enhance the pre-emergence herbicidal activity of the substantially dry corn gluten meal.

Embodiment 24 can include, or can optionally be combined with the subject matter of one or any combination of Embodiments 1-23, to optionally include the substantially dry corn gluten meal having a predetermined weight and the substantially dry solid acid having a predetermined weight, wherein the predetermined weight of the substantially dry corn gluten meal and the predetermined weight of the substantially dry acid are selected so a mixture of the predetermined weight of the substantially dry solid acid to the predetermined weight of the substantially dry corn gluten meal is effective to the re-emergence herbicidal activity of the substantially dry corn gluten meal.

Embodiment 25 can include, or can optionally be combined with the subject matter of one or any combination of Embodiments 1-24, to optionally include the instructions further comprising an instruction to apply the substantially dry corn gluten meal and the substantially dry solid acid to the plot of soil so that the substantially dry solid acid applied to the plot of soil has a weight of from about 0.01% to about 1% of a weight of the corn gluten meal applied to the plot of soil.

Embodiment 26 can include, or can optionally be combined with the subject matter of one or any combination of Embodiments 1-24, to optionally include the instructions further comprising an instruction to mix the substantially dry corn gluten meal with the substantially dry solid acid to form a substantially dry mixture so that the amount of the substantially dry solid acid in the mixture is effective to enhance the pre-emergence herbicidal activity of the substantially dry corn gluten meal.

Embodiment 27 can include, or can optionally be combined with the subject matter of one or any combination of Embodiments 1-26, to optionally include the instruction to mix the substantially dry corn gluten meal with the substantially dry solid acid comprising an instruction to form the substantially dry mixture so that the substantially dry solid acid has a weight from about 0.01% to about 1% of a weight of the corn gluten meal.

Embodiment 28 can include, or can optionally be combined with the subject matter of one or any combination of Embodiments 1-27, to optionally include the instructions to mix the substantially dry corn gluten meal with the substantially dry solid acid instructing mixing the substantially dry corn gluten meal with the substantially dry solid acid before applying the substantially dry corn gluten meal and the substantially dry solid acid to the plot of soil.

Embodiment 29 can include, or can optionally be combined with the subject matter of one or any combination of Embodiments 1-28, to optionally include the instructions comprising an instruction to apply the substantially dry corn gluten meal to the plot of soil separately from applying the substantially dry solid acid to the plot of soil.

Embodiment 30 can include, or can optionally be combined with the subject matter of one or any combination of Embodiments 1-28, to optionally include the instructions comprising an instruction to apply a combined amount of the substantially dry corn gluten meal and the substantially dry solid acid of from about 5 pounds to about 40 pounds per 1000 square feet of the soil.

Embodiment 31 can include, or can optionally be combined with the subject matter of one or any combination of Embodiments 1-30, to optionally include the substantially dry solid acid comprising at least one of citric acid, ethylenediaminetetraacetic acid, L-ascorbic acid, or ammonium sulfate.

Embodiment 32 can include, or can optionally be combined with the subject matter of one or any combination of Embodiments 1-31, to optionally include the corn gluten meal comprising from about 50% protein about 80% protein on a dry basis.

Embodiment 33 can include, or can optionally be combined with the subject matter of one or any combination of Embodiments 1-32, to include subject matter (such as an apparatus, a composition, a kit, a device, a method, or one or more means for performing acts), such as can include a method for selectively inhibiting the growth of undesirable plants. The subject matter can include applying a substantially dry corn gluten meal and a substantially dry solid acid to the plot of soil prior to the emergence of the undesirable plants in a plot of soil so that the amount of the substantially dry solid acid applied to the plot of soil is effective to enhance the pre-emergence herbicidal activity of the substantially dry corn gluten meal, wherein the substantially dry corn gluten meal and the substantially dry acid are applied in an amount effective to inhibit the growth of the undesirable plants.

Embodiment 34 can include, or can optionally be combined with the subject matter of one or any combination of Embodiments 1-33, to optionally include the substantially dry solid acid applied to the plot of soil having a weight of from about 0.01% to about 1% of a weight of the corn gluten meal.

Embodiment 35 can include, or can optionally be combined with the subject matter of one or any combination of Embodiments 1-34, to optionally include the substantially dry corn gluten meal and the substantially dry solid acid being applied in an amount effective to inhibit root development of the undesirable plants.

Embodiment 36 can include, or can optionally be combined with the subject matter of one or any combination of Embodiments 1-35, to optionally include the plot of soil comprising one or more desirable plants.

Embodiment 37 can include, or can optionally be combined with the subject matter of one or any combination of Embodiments 1-36, to optionally include transplanting one or more desirable plants into the plot of the soil.

Embodiment 38 can include, or can optionally be combined with the subject matter of one or any combination of Embodiments 1-37, to optionally include the desirable plants comprising at least one of monocotyledonous plants, turfgrasses, dicotyledonous plants, berry plants, or ornamental flowers.

Embodiment 39 can include, or can optionally be combined with the subject matter of one or any combination of Embodiments 1-38, to optionally include the undesirable plants being grassy weeds or broadleaf weeds.

Embodiment 40 can include, or can optionally be combined with the subject matter of one or any combination of Embodiments 1-39, to optionally include mixing the substantially dry corn gluten meal with the substantially dry solid acid to form a substantially dry mixture prior to applying the substantially dry corn gluten meal and the substantially thy solid acid to the plot of soil so that the amount of the substantially dry solid acid in the mixture is effective to enhance the pre-emergence herbicidal activity of the substantially dr corn gluten meal.

Embodiment 41 can include, or can optionally be combined with the subject matter of one or any combination of Embodiments 1-40, to optionally include the substantially dry solid acid in the mixture having a weight of from about 0.01% to about 1% of a weight of the corn gluten meal.

Embodiment 42 can include, or can optionally be combined with the subject matter of one or any combination of Embodiments 1-41, to optionally include the substantially dry corn gluten meal and the substantially dry solid acid being applied separately to the plot of soil.

Embodiment 43 can include, or can optionally be combined with the subject matter of one or any combination of Embodiments1-42, to optionally include the substantially dry corn gluten meal and the substantially dry solid acid being applied substantially concurrently to the plot of soil.

Embodiment 44 can include, or can optionally be combined with the subject matter of one or any combination of Embodiments 1-43, to optionally include the combined amount of the substantially dry corn gluten meal and the substantially dry solid acid applied to the plot of soil being from about 5 pounds to about 40 pounds per 1000 square feet of soil.

The above detailed description includes references to the accompanying drawings, which form a part of the detailed description. The drawings show, by way of illustration, specific embodiments in which the invention can be practiced. These embodiments are also referred to herein as “examples” or “embodiments.” Such examples or embodiments can include elements in addition to those shown or described. However, the present inventors also contemplate examples or embodiments in which only those elements shown or described are provided. Moreover, the present inventors contemplate examples or embodiments using any combination or permutation of those elements shown or described (or one or more aspects thereof), either with respect to a particular example or embodiment (or one or more aspects thereof), or with respect to other examples or embodiments (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, kit, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the detailed description, with each claim standing on its own as a separate embodiment. The scope of the invention should be determined with reference to the appended claims, along with the full scope of equivalents to which such claims are entitled.

All publications, patents and patent applications are incorporated herein by reference. While in the foregoing specification the disclosure has been described in relation to certain examples, and many details have been set forth for purposes of illustration, it will be apparent to those skilled in the art that the invention is susceptible to additional embodiments and that certain of the details described herein may be varied considerably without departing from the basic principles of the disclosure.

1. A composition comprising a substantially dry mixture of:
substantially dry corn gluten meal; and
substantially dry solid acid;
wherein the amount of the substantially dry solid acid is effective to enhance the pre-emergence herbicidal activity of the substantially dry corn gluten meal.

2. The composition of claim 1, wherein the substantially dry solid acid has a weight of from about 0.01% to about 1% of the weight of the substantially dry corn gluten meal.

3. The composition according to claim 1, wherein the substantially dry solid acid comprises at least one of citric acid, ethylenediaminetetraacetic acid, L-ascorbic acid, or ammonium sulfate.

4. The composition according to claim 1, wherein the corn gluten meal comprises from about 50% protein to about 80% protein on a dry basis.

5. The composition according to claim 1, wherein the substantially dry solid acid is citric acid having a weight of from about 0.01% to about 0.5% of a weight of the substantially dry corn gluten meal.

6. The composition according to claim 5, wherein the substantially dry citric acid comprises at least one of citric acid monohydrate or anhydrous citric acid.

7. A method comprising mixing a substantially dry corn gluten meal with a substantially dry solid acid to form a substantially dry mixture, wherein the amount of the substantially dry solid acid in the substantially dry mixture is effective to enhance the pre-emergence herbicidal activity of the :substantially dry corn gluten meal.

8. The method of claim 7, wherein the substantially dry solid acid has a weight of from about 0.01% to about 1% of a weight of the substantially dry corn gluten meal.

9. The method according to claim 7, further comprising grinding the corn gluten meal and the dry acid so that each have an average particle size of less than about 3 mm.

10. The method according to claim 7, wherein the substantially dry solid acid comprises at least one of citric acid, ethylenediaminetetraacetic acid, L-ascorbic acid, or ammonium sulfate.

11. The method according to claim 7, wherein the corn gluten meal comprises from about 50% protein to about 80% protein on a dry basis.

12. The method according to claim 7, further comprising applying the substantially dry mixture to a plot of soil prior to emergence of undesirable plants in an amount of the mixture effective to inhibit growth of the undesirable plants.

13. The method according to claim 12, wherein the substantially dry mixture is applied to the plot of soil after transplanting desirable plants into the plot of soil.

14. The method according to claim 12, wherein the amount of the substantially dry mixture that is added to the plot of soil is from about 5 pounds to about 40 pounds per 1000 square feet.

15. The method according to claim 12, wherein the amount of the substantially dry mixture that is added to the plot of soil is about 15 pounds per 1000 square feet of the soil.

16. A kit comprising separately packaged:
a substantially dry corn gluten meal;
a substantially dry solid acid; and
instructions for applying the substantially dry corn gluten meal and the substantially dry acid to a plot of soil so that the amount of the substantially dry solid acid applied to the plot of soil is effective to enhance the pre-emergence herbicidal activity of the substantially dry corn gluten meal.

17. The kit according to claim 16, wherein the substantially dry corn gluten meal has a predetermined weight and the substantially dry solid acid has a predetermined weight, wherein the predetermined weight of the substantially dry corn gluten meal and the predetermined weight of the substantially dry acid are selected so a mixture of the predetermined weight of the substantially dry solid acid to the predetermined weight of the substantially dry corn gluten meal is effective to enhance the pre-emergence herbicidal activity of the substantially dry corn gluten meal.

18. The kit according to claim 16, wherein the instructions further comprise an instruction to apply the substantially dry corn gluten meal and the substantially dry solid acid to the plot of soil so that the substantially dry solid acid applied to the plot of soil has a weight of from about 0.01% to about 1 ° A of a weight of the corn gluten meal applied to the plot of soil.

19. The kit according to claim 16, wherein the instructions further comprise an instruction to mix the substantially dry corn gluten meal with the substantially dry solid acid to form a substantially dry mixture so that the amount of the substantially dry solid acid in the mixture is effective to enhance the pre-emergence herbicidal activity of the substantially dry corn gluten meal.

20. The kit according to claim 19, wherein the instruction to mix the substantially dry corn gluten meal with the substantially dry solid acid comprises an instruction to form the substantially dry mixture so that the substantially dry solid acid has a weight from about 0.01% to about 1% of a weight of the corn gluten meal.

21. The kit according to claim 19, wherein the instructions to mix the substantially dry corn gluten meal with the substantially dry solid acid instruct mixing the substantially dry corn gluten meal with the substantially dry solid acid before applying the substantially dry corn gluten meal and the substantially dry solid acid to the plot of soil.

22. The kit according to claim 16, wherein the instructions comprise an instruction to apply the substantially dry corn gluten meal to the plot of soil separately from applying the substantially dry solid acid to the plot of soil.

23. The kit according to claim 16, wherein the instructions comprise an instruction to apply a combined amount of the substantially dry corn gluten meal and the substantially dry solid acid of from about 5 pounds to about 40 pounds per 1000 square feet of the soil.

24. The kit according to claim 16, wherein the substantially dry solid acid comprises at least one of citric acid, ethylenediaminetetraacetic acid, L-ascorbic acid, or ammonium sulfate.

25. The kit according to claim 16, wherein the corn gluten meal comprises from about 50% protein to about 80% protein on a dry basis.

26. A method for selectively inhibiting the growth of undesirable plants, the method comprising, prior to the emergence of the undesirable plants in a plot of soil, applying a substantially dry corn gluten meal and a substantially dry solid acid to the plot of soil so that the amount of the substantially dry solid acid applied to the plot of soil is effective to enhance the pre-emergence herbicidal activity of the substantially dry corn gluten meal, wherein the substantially dry corn gluten meal and the substantially dry acid are applied in an amount effective to inhibit the growth of the undesirable plants.

27. The method according to claim 26, wherein the substantially dry solid acid applied to the plot of soil has a weight of from about 0.01% to about 1% of a weight of the corn gluten meal.

28. The method according to claim 26, wherein the substantially dry corn gluten meal and the substantially dry solid acid are applied in an amount effective to inhibit root development of the undesirable plants.

29. The method according to claim 26, wherein the plot of soil comprises one or more desirable plants.

30. The method according to claim 26, further comprising transplanting one or more desirable plants into the plot of the soil.

31. The method according to claim 26, further comprising, prior to applying the substantially dry corn gluten meal and the substantially dry solid acid to the plot of soil, mixing the substantially dry corn gluten meal with the substantially dry solid acid to form a substantially dry mixture so that the amount of the substantially dry solid acid in the mixture is effective to enhance the pre-emergence herbicidal activity of the substantially dry corn gluten meal.

32. The method according to claim 26, wherein the substantially dry corn gluten meal and the substantially dry solid acid are applied separately to the plot of soil.

33. The method according to claim 26, wherein the substantially dry corn gluten meal and the substantially dry solid acid are applied substantially concurrently to the plot of soil.

34. The method according to claim 26, wherein the combined amount of the substantially dry corn gluten meal and the substantially dry solid acid applied to the plot of soil is from about 5 pounds to about 40 pounds per 1000 square feet of soil.
